(19) United States
(12) Patent Application Publication
(10) Pub. No.: US 2006/0105798 A1
(43) Pub. Date: May 18, 2006

(54) Method and apparatus for outer-loop power control for enhanced uplink communications

(76) Inventors: Amitava Ghosh, Buffalo Grove, IL (US); Rapeepat Ratasuk, Hoffman Estates, IL (US); Nick W. Whinnett, Marlborough (GB)

Correspondence Address: MOTOROLA, INC., 1303 EAST ALGONQUIN ROAD, IL01/3RD, SCHAUMBURG, IL, 60196, US

(21) Appl. No.: 11/268,944

(22) Filed: Nov. 8, 2005

Related U.S. Application Data
(60) Provisional application No. 60/627,933, filed on Nov. 15, 2004.

(51) Int. Cl. H04B 7/00

(52) U.S. Cl. 455/522; 455/69

(57) ABSTRACT

Various embodiments are described to address the need for an apparatus and method of outer-loop power control for enhanced uplink communications that address some of the outstanding problems in the prior art. Generally expressed, a base site (131), while a first uplink channel is inactive, monitors packet retransmissions to generate an uplink quality indicator. Here, packet retransmissions refers to the number of packet retransmissions used by a remote unit (101) to send packets to a base transceiver station (111) via at least one other uplink channel. Also, while the first uplink channel is inactive, the base site adjusts a signal-to-interference ratio (SIR) target for the first uplink channel based on the uplink quality indicator. Then, when the first uplink channel becomes active, the base site begins power controlling the first uplink channel using the SIR target.

### REFERENCE(S) TO RELATED APPLICATION(S)

The present application claims priority from provisional application Ser. No. 60/627,933, entitled “METHOD AND APPARATUS FOR OUTER-LOOP POWER CONTROL FOR ENHANCED UPLINK COMMUNICATIONS,” filed Nov. 15, 2004, which is commonly owned and incorporated herein by reference in its entirety.

### FIELD OF THE INVENTION

The present invention relates generally to wireless communication systems and, in particular, to outer-loop power control for enhanced uplink communications.

### BACKGROUND OF THE INVENTION

At present, standards bodies such as 3GPP (3rd Generation Partnership Project) are developing standards specifications for enhanced uplink (EUL) operation. (3GPP may be contacted via http://www.3qpp.org/.) One aspect of EUL operation being considered is how to provide outer loop power control (OLPC) for the enhanced data channel (E-DCH). In Rel-99, outer-loop power control resides in the radio network controller (RNC), and it sets the DPCCH (Dedicated Physical Control Channel) SNR (signal-to-noise ratio) set-point across all cells in a UE's (user equipment's) active set. Two existing algorithms that may be used for setting the Rel-99 outer-loop set-point are: 1) saw-tooth algorithms and 2) self-adjusting outer-loop (SAOL) algorithms. While the outer-loop saw-tooth algorithm is typically used for controlling Rel-99 services for which the target Frame Error Rate (FER) requirement is equal to or higher than 1%, the SAOL algorithm may be used if the target FER requirement is less than 0.1%.

Briefly, the SAOL algorithm works as follows. When an RNC receives frame quality information indicating a frame erasure, it adjusts the target signal-to-interference ratio (SIR_target) upward by upDelta. After TB_rolling_mark consecutive good blocks are received, the algorithm adjusts SIR_target downward by dnDelta. In between, the SIR_target is fine-tuned by floatDelta to handle small channel fluctuations. A salient feature of this algorithm is that upDelta, dnDelta, and TB_rolling_mark are not fixed, but rather dependent on the current channel conditions. This enables the transmit power to be minimized while at the same time able to combat varying fading conditions.

It has been proposed to operate a single outer-loop based on one reference channel, either the E-DCH or the DCH (data channel). When both DCH and E-DCH are active, the outer-loop can be run on the DCH due to the intermittent and discontinuous nature of the E-DCH. When only the E-DCH is active, the outer-loop can operate on the E-DCH. However, because of the bursty nature of the E-DCH and with changing power requirements due to varying Modulation and Coding Selection (MCS) selection, outer-loop operation based on the E-DCH may result in poor tracking.

It has alternatively been proposed to operate a single outer-loop based on the DCH and control the target error rates of different priority classes on the E-DCH with power offsets assigned by the Node B. However, since the required power offset to track both the DCH and E-DCH changes with propagation conditions, it is expected to be very difficult to satisfactorily track both channels using this approach.

Accordingly, it would be highly desirable to have an apparatus and method of outer-loop power control for enhanced uplink communications that address some of the outstanding problems in the prior art.

### BRIEF DESCRIPTION OF THE DRAWINGS

FIG. 1 is a block diagram depiction of a wireless communication system in accordance with multiple embodiments of the present invention.

FIG. 2 is a logic flow diagram of functionality performed by a base site in accordance with multiple embodiments of the present invention.

FIG. 3 is a more detailed logic flow diagram of functionality performed by a base site in accordance with certain embodiments of the present invention.

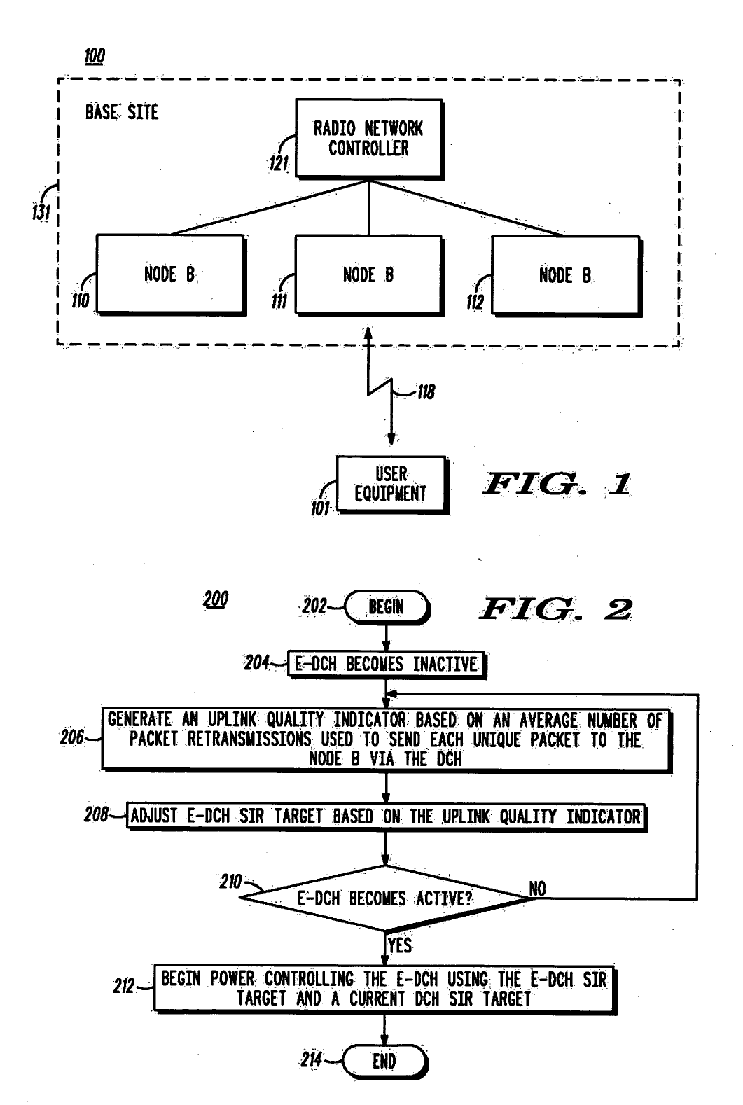

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to address the need for an apparatus and method of outer-loop power control for enhanced uplink communications that address some of the outstanding problems in the prior art. Generally expressed, a base site, while a first uplink channel is inactive, monitors packet retransmissions to generate an uplink quality indicator. Here, packet retransmissions refers to the number of packet retransmissions used by a remote unit to send packets to a base transceiver station via at least one other uplink channel. Also, while the first uplink channel is inactive, the base site adjusts a signal-to-interference ratio (SIR) target for the first uplink channel based on the uplink quality indicator. Then, when the first uplink channel becomes active, the base site begins power controlling the first uplink channel using the SIR target.

The disclosed embodiments can be more fully understood with reference to FIGS. 1-3. FIG. 1 is a block diagram depiction of a wireless communication system 100 in accordance with multiple embodiments of the present invention. Communication system 100 represents a system having an architecture in accordance with one or more of the specifications described in the 3GPP standards (such as a Universal Mobile Telecommunications System (UMTS), e.g.), suitably modified to implement the present invention. Alternative embodiments of the present invention may be implemented in communication systems that employ other (or additional) technologies such as, but not limited to, those specified in the 3GPP2 standards.

More specifically, communication system 100 comprises user equipment (UE) 101 and base site 131. Generically, base site 131 comprises a base controller and some base transceiver stations. For the particular implementation depicted, radio network controller (RNC) 121 serves as the base controller and Node Bs 110-112 serve as the base transceiver stations. However, those skilled in the art will recognize that FIG. 1 does not depict all of the network equipment necessary for system 100 to operate but only those system components and logical entities particularly relevant to the description of embodiments herein.

As depicted in system 100, Node B 111 and UE 101 communicate via code division multiple access (CDMA) air interface 118. Air interface 118 comprises a variety of well-known CDMA channel types (except to the extent modified by embodiments described herein), some of which are dynamically assigned and de-assigned to support user services as they are requested. For example, air interface 118 may comprise channels of channel types such as broadcast channels, paging channels, access channels, control channels, traffic channels, and/or power control channels. The uplink transport channels of air interface 118 that are particularly relevant to the embodiments described herein are the data channel (DCH) and the enhanced data channel (E-DCH). The corresponding physical channels that carry these transport channels are the Dedicated Physical Data Channel (DPDCH) and the Enhanced-Dedicated Physical Data Channel (E-DPDCH), respectively.

A remote unit/user equipment is known to refer to a wide variety of consumer electronic platforms such as, but not limited to, mobile stations (MSs), access terminals (ATs), terminal equipment, gaming devices, personal computers, personal digital assistants (PDAs), cable set-top boxes and satellite set-top boxes. Base sites, which include base transceiver station platforms and base controller platforms, are also well-known in the area of wireless telecommunications.

Therefore, given an algorithm, a logic flow, a messaging/signaling flow, a call flow, and/or a protocol specification, those skilled in the art are aware of the many design and development techniques available to implement a platform that performs the given logic. Furthermore, those skilled in the art will recognize that aspects of the present invention may be implemented in and across various physical components and none are necessarily limited to single platform implementations. For example, the base site aspect of the present invention may be implemented in a base transceiver station, in a base controller, or across both a base transceiver station and a base controller.

Operation of embodiments in accordance with the present invention occurs substantially as follows, first with reference to FIG. 2. FIG. 2 is a logic flow diagram of functionality performed by a base site in accordance with multiple embodiments of the present invention. Logic flow 200 begins (202) with an uplink channel (such as an E-DCH) of a remote unit/UE in an inactive state (204), perhaps having transitioned from an active to an inactive state but not necessarily. While the E-DCH is inactive, the base site monitors packet retransmissions by the UE, on one or more other uplink channels, to generate (206) an uplink quality indicator. In some embodiments, the base site, in generating the uplink quality indicator, determines over a period of time an average number of packet retransmissions (including hybrid automatic repeat request (HARQ) packet retransmissions where applicable) used by the UE to send each packet to the base site. Also, in some embodiments, the base site monitors the DCH associated with the E-DCH to generate the uplink quality indicator.

Then, based on the uplink quality indicator generated, the base site adjusts (208) a signal-to-interference ratio (SIR) target for the E-DCH. In some embodiments, a threshold is used is determine whether to increase or decrease the E-DCH SIR target. For example, if the uplink quality indicator represents an average retransmission rate then the E-DCH SIR target would be increased when this average retransmission rate reaches the retransmission rate threshold, otherwise the E-DCH SIR target would be decreased.

This cycle of generating the uplink quality indicator based on UE packet retransmissions and then adjusting the E-DCH SIR target continues while (210) the E-DCH remains inactive. When the E-DCH becomes active, the base site then uses the E-DCH SIR target to power control (212) the E-DCH. In some embodiments, such as those in which the uplink channels involved are the E-DCH and the DCH, power controlling the E-DCH also involves using the current DCH SIR target. For example, to change the power of the E-DCH the SIR targets for the E-DCH and DCH are used to adjust the power offset factor between the E-DCH and the DCH.

Logic flow 200 ends (214) with the base site beginning to use the current E-DCH and DCH SIR targets to power control the E-DCH. However, these SIR targets will continue to change with time, in accordance with the outer loop algorithms of each channel. Thus, while the E-DCH is active, the base site will use these changing SIR targets to power control the E-DCH.

In some embodiments, with the E-DCH active and the base site decoding received packets, the base site adjusts the E-DCH SIR target based on whether packet errors are detected. For example, the base site may increase the E-DCH SIR target on a packet-by-packet basis when a packet error is detected with the first HARQ transmission of a packet. Additionally, it may decrease the E-DCH SIR target on a packet-by-packet basis when a packet is successfully received on its first HARQ transmission. Clearly, there are many different permutations to how the base site may adjust the E-DCH SIR target based on packet errors. For example, instead of focusing on the first HARQ transmission of a packet, the base site may use the number of retransmissions that were required for a successful decode of a packet to adjust the E-DCH SIR target.

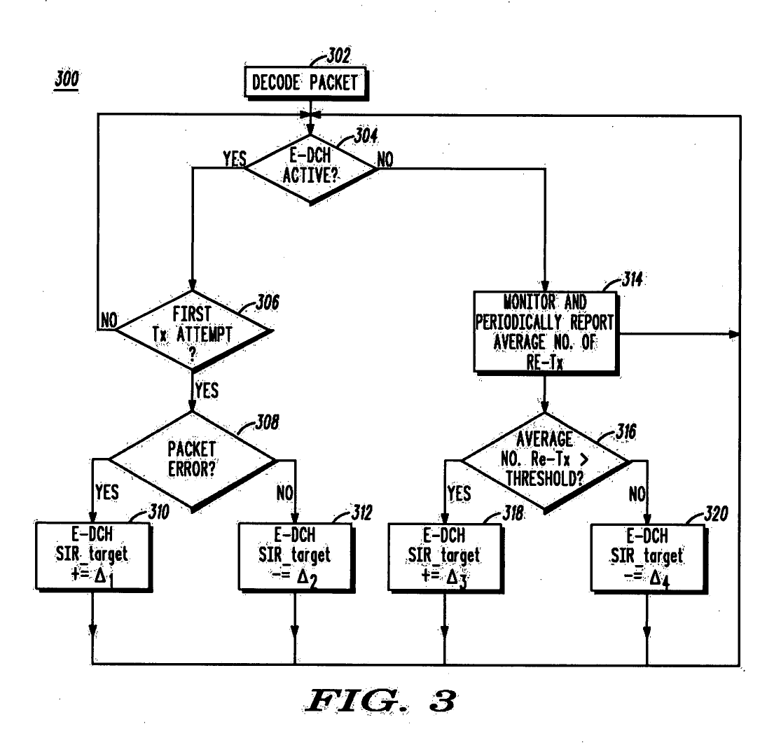

A discussion of certain embodiments in greater detail follows with reference to FIGS. 1 and 3. FIG. 1 depicts a particular base site architecture in which RNC 121 serves as a base controller for the base transceiver stations (i.e., Node Bs 110-112). FIG. 3 is a more detailed logic flow diagram of functionality performed by a base site in accordance with certain embodiments of the present invention. Logic flow 300 begins with the decoding (302) of a packet by Node B 111 from UE 101. If (304) the packet is transmitted via an E-DCH of air interface 118 (i.e., the E-DCH is therefore active), the packet is from the first HARQ transmission (306) and no packet error (308) is detected (e.g., CRC passed), the decoded packet is sent to RNC 121. The successful decode, without HARQ retransmission is also indicated to RNC 121, and in response RNC 121 lowers (312) the E-DCH SIR target by SIR_delta_{—}2.

However, if instead of a successful first decode a packet error is detected (e.g., CRC failed), this too is indicated to RNC 121, and in response RNC 121 increases (310) the E-DCH SIR target by SIR_delta_{—}1. The success or failure of the packet decode should also be sent in the case where a pending transmission is flushed via a New Data Indicator, such as during soft handoff when the packet is decoded by a different Node B. Also, note that SIR_delta_{—}1 and SIR_delta_{—}2 may be determined/adjusted based on the target E-DCH frame error rate of the first packet transmission. For example, SIR_delta_{—}1 could be set as follows: SIR_delta_{—}1=SIR_delta_{—}2*((target EDCH FER)/(1−target E-DCH FER)) where SIR_delta_{—}2 is a fixed constant.

The indication of whether a packet was decoded correctly or not after the 1st HARQ transmission may be sent to the RNC immediately upon decoding. However, in order to reduce signaling overhead between Node Bs and RNCs, whenever a Node B successfully decodes a packet and sends it to the RNC, it can, with the decoded packet, indicate whether the packet was decoded correctly or not after the 1st HARQ transmission or indicate how many retransmissions were required for a successful decode.

In the case were the E-DCH is not active (304), Node B 111 monitors (314) the number of packet retransmissions to generate an uplink quality indicator. In generating the uplink quality indicator, Node B 111 determines over a period of time (e.g., 100 milliseconds) an average number of packet retransmissions used by UE 101 to send each packet to Node B 111. Periodically then (e.g., every 100 milliseconds), Node B 111 sends the uplink quality indicator to RNC 121.

RNC 121 then compares (316) the uplink quality indicator (for these embodiments, an average number of packet retransmissions) to a threshold. When the average retransmission rate reaches the retransmission rate threshold, RNC 121 increases (318) the E-DCH SIR target by SIR_-delta_{—}3. Otherwise, RNC 121 decreases (320) the E-DCH SIR target by SIR_delta_{—}4.

When the E-DCH becomes active, RNC 121 instructs Node B 111 to power control the E-DCH using the current E-DCH SIR target. Power controlling the E-DCH can also involve using the current DCH SIR target. For example, to change the power of the E-DCH the SIR targets for the E-DCH and DCH are used to adjust the power offset factor between the E-DCH and the DCH. In certain embodiments, power of the DPDCH and the E-DCH are determined from the gain factors beta_d (for DPDCH) and beta_ed (for E-DPDCH) and total physical channel power. Thus, with the addition of the E-DCH outer loop, power of the DPDCH and E-DCH should be adjusted through a coordinated process of dedicated physical channel power adjustment and re-selection of the beta_d and beta_ed gain factors.

The disclosure herein enables separate outer loops to be used to power control the E-DCH and DCH. The E-DCH outer-loop set-point is used to determine the power offset between the E-DCH and the DPCCH and subsequently to adjust the gain (beta) factors. Although an additional outer-loop introduces some additional complexity, this approach automatically adjusts the power offset between the two channels to maintain the desired operating error rates.

In summary, one way to address the discontinuous nature of E-DCH and DPDCH transmission, their different operating points, and the difficulty in determining the appropriate offsets between the E-DCH and DPCCH is to use two independent outer loops. Both of the OLPC loops may be based on the DPCCH but the algorithm for adjusting the OLPC set-point is different for the E-DPDCH and the DPDCH. While the DPDCH OLPC algorithm may be based on an existing algorithm such as the sawtooth algorithm, a new OLPC algorithm for the E-DCH is described herein in an attempt to account for the E-DCH's discontinuous nature and associated HARQ mechanism.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for outer-loop power control for enhanced uplink communications comprising:
while a first uplink channel is inactive, monitoring a number of packet retransmissions to generate an uplink quality indicator, wherein the number of packet retransmissions is the number of packet retransmissions used by a remote unit to send packets to a base transceiver station (BTS) via at least one other uplink channel;
while the first uplink channel is inactive, adjusting a signal-to-interference ratio (SIR) target for the first uplink channel based on the uplink quality indicator; and
when the first uplink channel becomes active, power controlling the first uplink channel using the SIR target.

2. The method of 1, wherein power controlling the first uplink channel using the SIR target comprises power controlling the first uplink channel using the SIR target and a SIR target for the at least one other uplink channel.

3. The method of 2,
wherein the first uplink channel comprises an enhanced data channel (E-DCH),
wherein the at least one other uplink channel comprises a data channel (DCH),
wherein power controlling the first uplink channel comprises adjusting a power offset factor between the E-DCH and associated DPCCH to change the power of the E-DCH, and
wherein the SIR target and the SIR target for the DCH are used to adjust the power offset of the E-DCH and the DCH.

4. The method of 1,
wherein the first uplink channel comprises an enhanced data channel (E-DCH) that is a transport channel carried on the Enhanced-Dedicated Physical Data Channel (E-DPDCH),
wherein the at least one other uplink channel comprises a data channel (DCH) that is a transport channel carried on the Dedicated Physical Data Channel (DPDCH), and
wherein the BTS comprises a Node B.

5. The method of 4, wherein separate outer loops are used to power control the E-DCH and DCH.

6. The method of 1,
wherein monitoring the number of packet retransmissions to generate an uplink quality indicator comprises generating the uplink quality indicator based on an average number of packet retransmissions over a period of time.

7. The method of 6,
wherein monitoring the number of packet retransmissions to generate an uplink quality indicator comprises generating the uplink quality indicator based on hybrid automatic retransmission request (HARQ) packet retransmissions.

8. The method of 1,
wherein adjusting the SIR target for the first uplink channel comprises increasing the SIR target when the uplink quality indicator reaches a threshold.

9. The method of 8,
wherein adjusting the SIR target for the first uplink channel comprises decreasing the SIR target when the uplink quality indicator does not reach the threshold.

10. The method of 1, further comprising
periodically sending by the BTS the uplink quality indicator to a base controller,
wherein monitoring the number of packet retransmissions comprises monitoring by the BTS the number of packet retransmissions, and
wherein adjusting the SIR target comprises adjusting by the base controller the SIR target.

11. The method of 1, further comprising:
while the first uplink channel is active, decoding, by the BTS, a packet received from the remote unit via the first uplink channel, wherein the received packet is a first HARQ transmission of the packet; and
when a packet error is detected for the received packet, increasing a SIR target for the first uplink channel.

12. The method of 11, further comprising:
when a packet error is not detected for the received packet, decreasing SIR target for the first uplink channel.

13. The method of 11, further comprising:
sending by the BTS an indication to a base controller that the packet error was detected, wherein increasing the SIR target for the first uplink channel comprises increasing the SIR target by the base controller.

14. The method of 11, wherein sending by the BTS the indication to the base controller that the packet error was detected comprises sending the indication with the decoded packet.

15. The method of 11, wherein sending by the BTS the indication to the base controller that the packet error was detected comprises sending an indication with the decoded packet of how many retransmissions were required for a successful decode.

16. A base site comprising:
a base transceiver station (BTS) adapted to monitor, while a first uplink channel is inactive, a number of packet retransmissions to generate an uplink quality indicator, wherein the number of packet retransmissions is the number of packet retransmissions used by a remote unit to send packets to the BTS via at least one other uplink channel; and
a base controller, communicatively coupled to the BTS,
adapted to adjust, while the first uplink channel is inactive, a signal-to-interference ratio (SIR) target for the first uplink channel based on the uplink quality indicator and
adapted to instruct the BTS to power control the first uplink channel using the SIR target when the first uplink channel becomes active.

17. The base site of 16, wherein the BTS comprises a Node B and wherein the base controller comprises a radio network controller (RNC).

18. The base site of 16, wherein the BTS is further adapted to power control the first uplink channel using the SIR target and a SIR target for the at least one other uplink channel.

19. The base site of 18,
wherein the first uplink channel comprises an enhanced data channel (E-DCH),
wherein the at least one other uplink channel comprises a data channel (DCH),
wherein power controlling the first uplink channel comprises adjusting a power offset factor between the E-DCH and associated DPCCH to change the power of the E-DCH, and
wherein the SIR target and the SIR target for the DCH are used to adjust the power offset of the E-DCH and the DCH.

20. The base site of 16,
wherein the first uplink channel comprises an enhanced data channel (E-DCH) that is a transport channel carried on the Enhanced-Dedicated Physical Data Channel (E-DPDCH),
wherein the at least one other uplink channel comprises a data channel (DCH) that is a transport channel carried on the Dedicated Physical Data Channel (DPDCH), and
wherein the BTS comprises a Node B.
